(19) United States
(12) Patent Application Publication
(10) Pub. No.: US 2016/0123180 A1
(43) Pub. Date: May 5, 2016

(54) OVER SPEED MONITORING USING A FAN DRIVE GEAR SYSTEM

(71) Applicant: UNITED TECHNOLOGIES CORPORATION, Hartford, CT (US)

(72) Inventor: John R. Otto, Middletown, CT (US)

(21) Appl. No.: 14/894,567

(22) PCT Filed: Jun. 12, 2014
(86) PCT No.: PCT/US2014/042029

§ 371 Date: Nov. 30, 2015

Related U.S. Application Data
(60) Provisional application No. 61/838,409, filed on Jun. 24, 2013.

(51) Int. Cl. F01D 21/00; F02K 3/00

(52) U.S. Cl. CPC F01D 21/003; F02K 3/00; F05D 2260/80; F05D 2260/40311; F05D 2270/021

(57) ABSTRACT

A control system for turbofan engine includes a first sensor measuring rotation of a first shaft at a first location and a fan shaft sensor measuring a speed of a fan shaft. A controller utilizes measurements of a first speed of the first shaft from the first sensor and a second speed of the fan shaft driven by a geared architecture and rotating at a speed different than the first shaft. The controller determines that one of the first shaft and the fan shaft are outside predetermined deformation limits responsive to a difference between an actual difference between the first and second speeds and a calculated expected difference between speeds of the first shaft and the fan shaft.

### CROSS REFERENCE TO RELATED APPLICATION

This application claims priority to U.S. Provisional Application No. 61/838,409 filed on Jun. 24, 2013.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the inner shaft. A speed of the low spool and the high spool is measured in different locations to monitor shaft integrity. A difference between measured speeds can be indicative of torsional effects and failure of the spool.

A speed reduction device such as an epicyclical gear assembly may be utilized to drive the fan section such that the fan section may rotate at a speed different than the turbine section to increase overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds. The different operating speeds of the gear assembly and the fan section can complicate monitoring of speeds of the low spool driving the fan section.

Turbine engine manufacturers continue to seek improvements to engine performance including improvements to shaft monitoring systems.

### SUMMARY

A method of controlling a turbofan engine, the turbofan engine including a rotating shaft coupling a turbine to a compressor and driving a fan through a geared architecture according to an exemplary embodiment of this disclosure, among other possible things includes measuring a first speed of the rotating shaft at a first location aft of the geared architecture, measuring a second speed of a fan drive shaft driven by the geared architecture and rotating at a speed different than the rotating shaft, calculating an expected difference in speed of the rotating shaft and the fan drive shaft based on a gear ratio of the geared architecture, and determining that one of the rotating shaft and the fan drive shaft are outside predefined deformation limits responsive to a difference between an actual difference between the first and second speeds and the calculated expected difference.

In a further embodiment of the foregoing method, the gear reduction ratio is greater than about 2.3.

In a further embodiment of any of the foregoing methods, the rotating shaft includes a low spool shaft coupling a low pressure turbine to a low pressure compressor.

In a further embodiment of any of the foregoing methods, the rotating shaft includes a turbine section directly coupled to drive the geared architecture.

In a further embodiment of any of the foregoing methods, includes measuring the first speed of the rotating shaft at a second location forward of the first location.

In a further embodiment of any of the foregoing methods, includes measuring the first speed at both the first location and the second location and determining that the rotating shaft is outside the predefined deformation limits responsive to a difference in measurements at the first location and the second location exceeding a predetermined range.

In a further embodiment of any of the foregoing methods, includes a second rotating shaft coupling a high pressure compressor to a high pressure turbine and sensing a speed of the second rotating shaft at more than one location and determining a deformation beyond the predefined limit in the second rotating shaft responsive to a difference in measured speed at the more than one locations exceeding a predetermined range.

In a further embodiment of any of the foregoing methods, the predefined deformation limits includes predefined torsion limits.

A control system for turbofan engine according to an exemplary embodiment of this disclosure, among other possible things includes a first sensor measuring rotation of a first shaft at first location, a fan shaft sensor measuring a speed of the fan shaft, and a controller utilizing measurements of a first speed of the first shaft from the first sensor. A second speed of the fan shaft is driven by a geared architecture and rotating at a speed different than the first shaft for determining that one of the first shaft and the fan shaft are outside a predefined deformation limits responsive to a difference between an actual difference between the first and second speeds and a calculated expected difference between speeds of the first shaft and the fan shaft.

In a further embodiment of the foregoing control system, the first sensor is mounted proximate the first shaft aft of a geared architecture and a second sensor measuring rotation of the first shaft is mounted at a second location spaced apart from the first location.

In a further embodiment of any of the foregoing control systems, the controller determines the calculated expected difference between the speed of the first shaft and the fan shaft based on a gear reduction ratio provided by the geared architecture.

In a further embodiment of any of the foregoing control systems, the gear reduction ratio is greater than about 2.3.

In a further embodiment of any of the foregoing control systems, the controller initiates shutdown of the turbofan engine responsive to the determination that one of the rotating shaft and the fan shaft are outside predefined deformation limits.

In a further embodiment of any of the foregoing control systems, the predefined deformation limits comprises predefined torsion limits.

A turbofan engine according to an exemplary embodiment of this disclosure, among other possible things includes a fan including a fan shaft and a plurality of fan blades rotatable about an axis, a combustor in fluid communication with a compressor section, and a turbine section in fluid communication with the combustor. The turbine section drives a first shaft with the first shaft providing a coupling between the turbine section and a compressor section. A geared architecture is driven by the first shaft for rotating the fan about the axis. A first sensor measures a speed of the first shaft. A fan shaft sensor measures a speed of the fan shaft. A controller utilizes measurements of a first speed of the first shaft from the first sensor. A second speed of the fan shaft is driven by a geared architecture and rotating at a speed different than the first shaft for determining that one of the first shaft and the fan shaft are outside predefined deformation limits responsive to a difference between an actual difference between the first and second speeds and a calculated expected difference between speeds of the first shaft and the fan shaft.

In a further embodiment of the foregoing turbofan engine, includes a second sensor measuring a speed of the first shaft at a location different than the first sensor.

In a further embodiment of any of the foregoing turbofan engines, the geared architecture includes a gear reduction ratio greater than about 2.3.

In a further embodiment of any of the foregoing turbofan engines, the controller initiates an engine shutdown responsive to determining that one of the first shaft and the fan shaft are outside the predetermined deformation limits.

In a further embodiment of any of the foregoing turbofan engines, the predefined deformation limits comprise predefined torsion limits.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example turbofan engine.

FIG. 2 is schematic view of the example turbofan engine including an example safety system.

### DETAILED DESCRIPTION

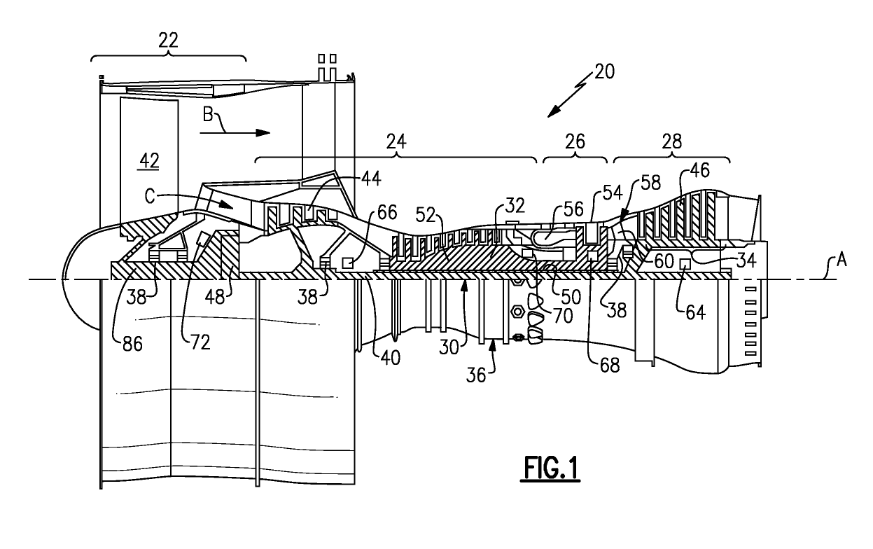

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

Airflow through the core airflow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by airflow through the bypass flow path B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7 ° R]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

The example turbine engine 20 includes first and second sensors 64 and 66 on the low speed spool 30 and first and second sensors 68, 70 on the high speed spool 32. The sensors 64, 66, 68 and 70 detect shaft speed at different locations of the corresponding shafts to provide information utilized to monitor and determine shaft health and condition.

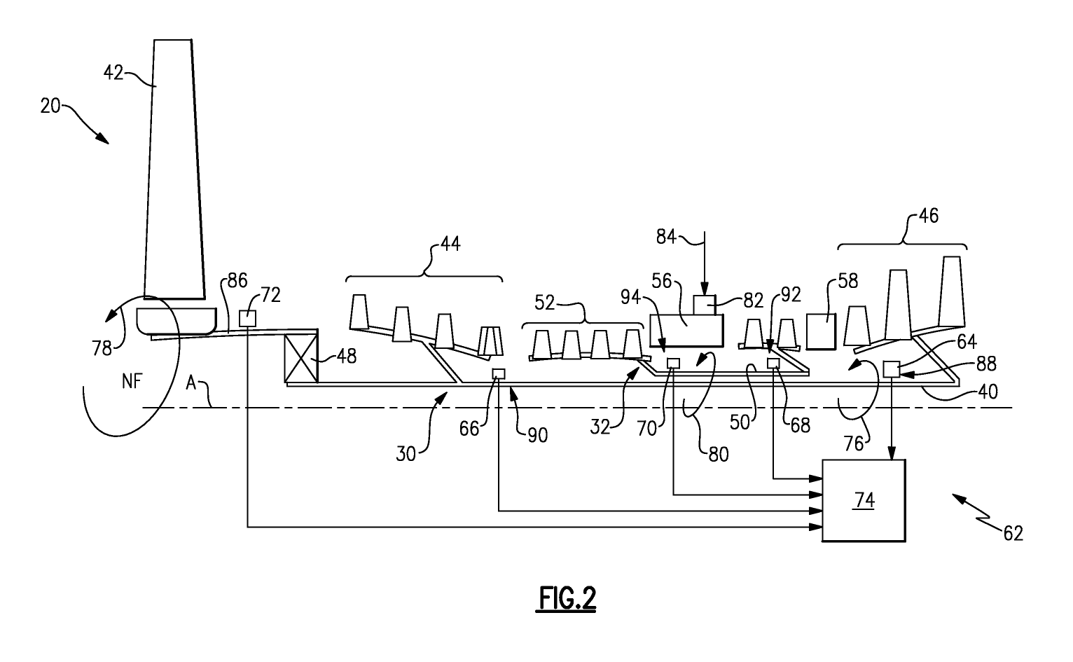

Referring to FIGS. 1 and 2, the engine 20 includes a control system 62 that receives data indicative of shaft speed from sensors positioned at different locations along each of the low spool 30, the high spool 32 and a fan shaft 86. The low spool 30 includes the low pressure turbine shaft 40 that rotates at a first speed 76. Differences in speed at different locations along the shaft 40 can be indicative of shaft deformation. Such deformation can include torsion, shear, bending or any other deformations that could change operational behavior.

Accordingly, the control system 62 gathers information from sensors at two locations along each of the low pressure shaft 40 and the high pressure shaft 50 and uses that information to detect differences in shaft speed that may be indicative of shaft deformation. Moreover, the control system 62 utilizes a speed 78 of the fan shaft 86 along with the known gear ratio to further detect potential issues with the shaft 40.

A first speed sensor 64 is disposed at an aft portion 88 of the low pressure shaft 40. A second speed sensor 66 is disposed at a forward portion 90 of the shaft 40. Differences in speed measured by the first sensor 64 and the second sensor 66 indicate that some deformation of the shaft 40 is present. Moreover, the high pressure shaft 50 includes a first sensor 68 located at an aft portion 92 and a second sensor 70 located at a forward portion 94 to further detect differences in the high pressure shaft 50.

The example turbofan engine 20 includes the geared architecture 48 for driving the fan 42 at a speed different than the low pressure turbine 46. The example geared architecture 48 drives the fan shaft 86 at a speed different than the low pressure turbine shaft 40. In this example, the low pressure turbine shaft 40 drives the geared architecture 48; however, other shafts could be utilized to drive the geared architecture within the contemplation of this disclosure.

The first speed sensor 64 is disposed at aft portion 88 that is aft of the geared architecture 48 and is at an aft portion of the low pressure turbine 46. The second speed sensor 66 is disposed at the forward portion that is aft of the geared architecture and forward of the combustor 56. A fan shaft sensor 72 is disposed on the fan shaft 86 and detects a speed of the fan shaft 86.

By utilizing the known gear reduction ratio of the geared architecture 48 and thereby the difference in speeds between the low pressure shaft 40 and the fan shaft 86, the speed 78 of the fan shaft 86 is utilized to determine the condition of the shaft 40. A difference in speeds between the fan shaft 86 and the shaft 40 will fall within a predetermined range based on the gear ratio during normal operation. Departure of the difference between the fan shaft 86 and the shaft 40 from the expected difference is utilized along with the first and second sensors 64, 66 to determine if defects are present.

In operation, each of the sensors 64, 66, 68 and 70 communicates information indicative of respective shaft speed to the controller 74. The controller 74 determines a difference between the measured speeds for sensors disposed on a common shaft and compares that with a predetermined limit to differences between the measured speeds. As appreciated, each of the sensors should measure a near identical speed at different locations for a shaft that is operating properly and does not include any defects.

The controller 74 will further determine a calculated difference in speeds between the shaft 40 and the fan shaft 86 based on the speed reduction gear ratio provided by the geared architecture 48. The controller 74 accounts for the relative direction between the shafts 48, 86 in order to determine an expected difference between speeds of the low pressure turbine shaft 40 and the fan shaft 86. If the actual difference in speed is different from the expected difference, the controller 74 will determine that at least one of the low shaft 40 and the fan shaft 86 is experiencing deformation outside of predetermined limits.

In the event that the controller 74 makes a determination based on a difference between the expected difference in shaft speeds and an actual measured difference between shaft speeds, the controller 74 will initiate a shutdown procedure of the engine. In one example, the shutdown procedure can include the utilization of a fuel control valve 82 to cutoff fuel flow 84 to the combustor 56 and thereby shutdown the fan engine 20.

Accordingly, the example safety system 62 operates to control the turbofan engine 20 by first measuring a first speed of the rotating low pressure turbine shaft 40 with at least one of the first sensor 64 and the second sensor 66. The controller 74 further gathers data of fan shaft speed 78 with the speed sensor 72. The controller 74 compares the difference in relative speeds between the low pressure turbine shaft 40 and the fan shaft 86. Because the geared architecture 48 includes a known gear ratio, the relative speed between the low pressure turbine shaft 40 and the fan shaft 86 should be within a predetermined and specified range.

If the measured difference in speeds of the low pressure turbine shaft 40 and the fan shaft 86 are outside of the calculated and expected difference in speeds, the controller 74 will make a determination based on this difference torsion is outside of the predetermined limits has occurred in one of the shaft 40 and the fan shaft 86. In response to such a determination, the controller 74 can initiate engine operations that will prevent engine damage such as a complete engine shut down.

Accordingly, the example system utilizes an additional sensor disposed on the fan shaft along with the known gear reduction ratio provided by the geared architecture to add a further means of monitoring shaft integrity for maintaining engine operation within desired parameters.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of controlling a turbofan engine, the turbofan engine including a rotating shaft coupling a turbine to a compressor and driving a fan through a geared architecture, the method comprising:
measuring a first speed of the rotating shaft at a first location aft of the geared architecture;
measuring a second speed of a fan drive shaft driven by the geared architecture and rotating at a speed different than the rotating shaft; calculating an expected difference in speed of the rotating shaft and the fan drive shaft based on a gear ratio of the geared architecture; and
determining that one of the rotating shaft and the fan drive shaft are outside predefined deformation limits responsive to a difference between an actual difference between the first and second speeds and the calculated expected difference.

2. The method as recited in claim 1, wherein the gear reduction ratio is greater than about 2.3.

3. The method as recited in claim 1, wherein the rotating shaft comprises a low spool shaft coupling a low pressure turbine to a low pressure compressor.

4. The method as recited in claim 1, wherein the rotating shaft comprises a turbine section directly coupled to drive the geared architecture.

5. The method as recited in claim 1, including measuring the first speed of the rotating shaft at a second location forward of the first location.

6. The method as recited in claim 5, including measuring the first speed at both the first location and the second location and determining that the rotating shaft is outside the predefined deformation limits responsive to a difference in measurements at the first location and the second location exceeding a predetermined range.

7. The method as recited in claim 1, including a second rotating shaft coupling a high pressure compressor to a high pressure turbine and sensing a speed of the second rotating shaft at more than one location and determining a deformation beyond the predefined limit in the second rotating shaft responsive to a difference in measured speed at the more than one locations exceeding a predetermined range.

8. The method as recited in claim 1, wherein the predefined deformation limits comprises predefined torsion limits.

9. A control system for turbofan engine comprising:
a first sensor measuring rotation of a first shaft at first location;
a fan shaft sensor measuring a speed of the fan shaft; and
a controller utilizing measurements of a first speed of the first shaft from the first sensor; a second speed of the fan shaft driven by a geared architecture and rotating at a speed different than the first shaft for determining that one of the first shaft and the fan shaft are outside a predefined deformation limits responsive to a difference between an actual difference between the first and second speeds and a calculated expected difference between speeds of the first shaft and the fan shaft.

10. The control system as recited in claim 9, wherein the first sensor is mounted proximate the first shaft aft of a geared architecture and a second sensor measuring rotation of the first shaft is mounted at a second location spaced apart from the first location.

11. The control system as recited in claim 9, wherein the controller determines the calculated expected difference between the speed of the first shaft and the fan shaft based on a gear reduction ratio provided by the geared architecture.

12. The control system as recited in claim 10, wherein the gear reduction ratio is greater than about 2.3.

13. The control system as recited in claim 9, wherein the controller initiates shutdown of the turbofan engine responsive to the determination that one of the rotating shaft and the fan shaft are outside predefined deformation limits.

14. The control system as recited in claim 9, wherein the predefined deformation limits comprises predefined torsion limits.

15. A turbofan engine comprising:
a fan including a fan shaft and a plurality of fan blades rotatable about an axis;
a combustor in fluid communication with a compressor section;
a turbine section in fluid communication with the combustor, the turbine section driving a first shaft with the first shaft providing a coupling between the turbine section and a compressor section;
a geared architecture driven by the first shaft for rotating the fan about the axis;
a first sensor measuring a speed of the first shaft;
a fan shaft sensor measuring a speed of the fan shaft; and
a controller utilizing measurements of a first speed of the first shaft from the first sensor; a second speed of the fan shaft driven by a geared architecture and rotating at a speed different than the first shaft for determining that one of the first shaft and the fan shaft are outside predefined deformation limits responsive to a difference between an actual difference between the first and second speeds and a calculated expected difference between speeds of the first shaft and the fan shaft.

16. The turbofan engine as recited in claim 15, including a second sensor measuring a speed of the first shaft at a location different than the first sensor.

17. The turbofan engine as recited in claim 15, wherein the geared architecture includes a gear reduction ratio greater than about 2.3.

18. The turbofan engine as recited in claim 15, wherein the controller initiates an engine shutdown responsive to determining that one of the first shaft and the fan shaft are outside the predetermined deformation limits.

19. The turbofan engine as recited in claim 15, wherein the predefined deformation limits comprise predefined torsion limits.
